(19) United States
(12) Patent Application Publication
(10) Pub. No.: US 2011/0016784 A1
(43) Pub. Date: Jan. 27, 2011

(54) Modular Wall Planters

(76) Inventor: Steve M. Taber, Bartonville, TX (US)

Correspondence Address: Klemchuk Kubasta LLP, 8150 N Central Expressway, SUITE 1150, DALLAS, TX, 75206, US

(21) Appl. No.: 12/797,276

(22) Filed: Jun. 9, 2010

Related U.S. Application Data
(60) Provisional application No. 61/228,312, filed on Jul. 24, 2009.

(51) Int. Cl. A01G 9/02

(52) U.S. Cl. 47/79

(57) ABSTRACT

The systems and methods of the present disclosure provide an integrated modular wall planter and method of creating a modular wall planter displays. The systems and methods could include using troughs, support systems, mounting brackets, guides, and irrigation system to create a modular display of troughs in an efficient and cost effective manner. The irrigation system could help to maintain the viability of any live plants used in the planter displays.

### CROSS REFERENCE TO RELATED APPLICATION

This application claims benefit under 35 U.S.C. §119(e) of U.S. Provisional Patent Application Ser. No. 61/228,312 filed on Jul. 24, 2010 in the United States Patent and Trademark Office entitled “Systems and Methods of Providing Modular Wall Planters.” The entire disclosure of U.S. Provisional Patent Application Ser. No. 61/228,312 is incorporated by reference as if fully disclosed herein.

### TECHNICAL FIELD

The disclosure relates generally to planters, and in particular to systems and methods of providing modular wall planters.

### BACKGROUND

Plants have long been used for many different purposes including providing vegetation for food sources, medicines, and cosmetics, and enhancing the aesthetics of surroundings in both residential and commercial areas.

### SUMMARY

Embodiments of the present disclosure generally provide integrated modular wall planters and planter displays in an efficient and cost effective manner.

In one embodiment, the present disclosure generally provides a modular planting system. The system could include a vertically disposed frame. The system could also include a removable trough having a retaining structure to position the trough relative to the frame. The system could further include an irrigation system having an outlet disposed above the trough.

In one embodiment, the present disclosure generally provides a modular planting system. The system could include a vertically disposed frame. The system could also include a first trough having a first support to selectively position the first trough relative to the frame. The system could further include a second trough having a second support to retain the second trough to the first trough. The system could still further include an irrigation system having an outlet disposed above the first trough and the second trough.

In one embodiment, the present disclosure could include a modular planting system. The system could also include a vertically disposed frame. The system could further include a first removable trough having a first support to position the first trough relative to the frame. The system could still further include a second removable trough having a second support to position the second trough relative to the frame. In addition, the system could include an irrigation system to supply water to the first and second troughs and an end trough to capture any water drainage from the second trough.

Other technical features may be readily apparent to one skilled in the art from the following figures and description.

### BRIEF DESCRIPTION OF THE DRAWINGS

For a more complete understanding of this disclosure and its features, reference is now made to the following description, taken in conjunction with the accompanying drawings, in which:

FIG. 1 is an exemplary perspective view of a modular wall planter system or display shown mounted on a planar surface according to one embodiment of the present disclosure;

FIG. 2A is an exemplary perspective view into a compartment of a trough associated with the modular wall planter system shown in FIG. 1 according to one embodiment of the present disclosure;

FIG. 2B is an exemplary perspective view into a compartment of a trough associated with the modular wall planter system shown in FIG. 1 according to one embodiment of the present disclosure;

FIG. 3 is an illustration of an exemplary irrigation system for use in conjunction with the modular wall planter system shown in FIG. 1 according to one embodiment of the present disclosure;

FIG. 4 is an exemplary side view a modular wall planter system according to one embodiment of the present disclosure;

FIGS. 5A, 5B, 5C, and 5D are exemplary configurations for a modular wall planter system according to one embodiment of the present disclosure;

FIG. 6 is an exemplary perspective view of an end trough of a modular planter system according to one embodiment of the present disclosure;

FIG. 7 is an exemplary irrigation system using the end trough shown in FIG. 6 according to one embodiment of the present disclosure;

FIG. 8 is an exemplary method of providing a modular planter system according to one embodiment of the present disclosure; and

FIG. 9 is an exemplary method of providing a modular planter system having an irrigation system such as, for example, the irrigation system shown in FIG. 3.

### DETAILED DESCRIPTION

The present disclosure generally provides systems and methods of providing integrated modular wall planters and planter displays in an efficient and cost effective manner. In one embodiment, the present disclosure provides an easy to assemble system and method of providing irrigation to maintain plant viability in such planter displays.

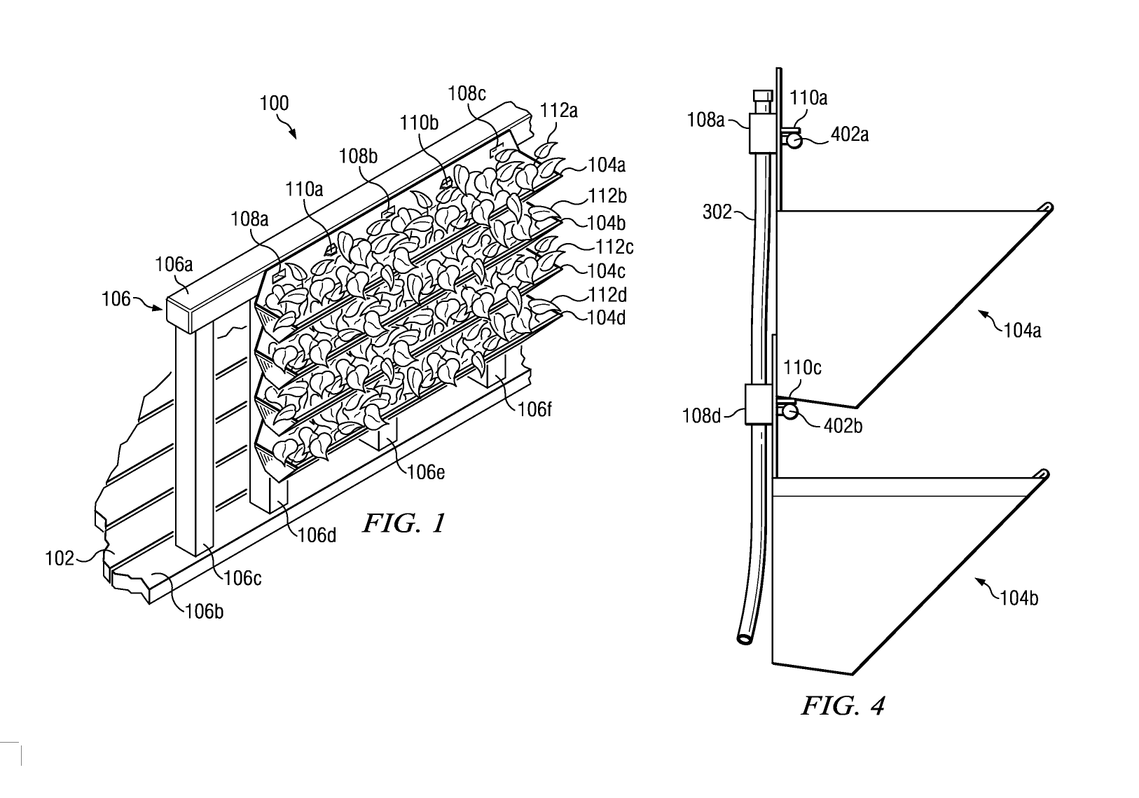

FIG. 1 is an exemplary perspective view of a modular wall planter system 100 according to one embodiment of the present disclosure. It should be understood that system 100 shown in FIG. 1 is for illustrative purposes only and that any other suitable system or subsystem could be used in conjunction with or in lieu of system 100 according to one embodiment of the present disclosure.

In FIG. 1, system 100 is shown supported and mounted on surface 102 according to one embodiment of the present disclosure. System 100 could include troughs 104a, 104b, 104c, and 104d (collectively referred to herein as troughs 104), support systems 106a, 106b, 106c, 106d, 106e, and 106f (collectively referred to herein as support systems 106), mounting brackets 108a, 108b, and 108c (collectively referred to herein as mounting brackets 108), and guides 110a and 110b (collectively referred to herein as guides 110). In one embodiment, system 100 could be used to provide a modular wall planter system to mount plants 112a, 112b, 112c, and 112d (collectively referred to herein as plants 112).

In the embodiment shown in FIG. 1, surface 102 could include any suitable surface, floor, base, or similar structure made of, for example, cement, concrete, wood, sheet rock, plaster, brick, brick veneer, metal, steel aluminum siding, glass, mirror, dirt, clay, stone, plastic, rubber, other suitable materials, or any combination thereof.

In one embodiment, surface 102 could generally include a planar surface suitable for supporting, retaining, mounting, positioning, or otherwise anchoring support systems 106. Although surface 102 is generally shown as a planar, slotted surface, it should be understood that any suitable number, size, shape, overall look, appearance, configuration, or utility for surface 102 could be used in accordance with the present disclosure.

Troughs 104 could include any material such as plastic, thermoplastic, rubber, metal, steel, stainless steel, aluminum, copper, wood, siding material, concrete, wire, tubing, ceramics, pottery, fiberglass, glass, mirror, clay, tile, stone, granite, quartz, shell, rope, paper, wicker, stick, biodegradable material, solar panel, foil, grass, foliage, soil, fabric, any suitable material, or any combination thereof.

Troughs 104 could include any color or combinations of color, paint, metal powder, patina, antiquing, paper, fabric, aesthetic, novelty items, decorative touches, lettering, finishes, any suitable treatments to change, alter, enhance, modify, differentiate, or customize the look of troughs 104, or any combination thereof.

Generally, troughs 104 could be configured to retain or otherwise house plants, miniature trees, shrubs, flowers, herbs, horticulture, soils, dirt, hydroponic materials, fertilizers, stones, shells, decorative items, novelty items, other suitable materials, or any combination thereof. It should, however, be understood that any suitable number, size, shape, overall look, appearance, configuration, or utility for troughs 104 could be used in accordance with the present disclosure.

Support systems 106 could include any suitable system or frame-like structure to generally help maintain a relative position between one or more troughs 104 and planar surface 102. In the embodiment shown in FIG. 1, support system 106 could include distal support 106a, proximate support 106b, and lateral supports 106c, 106d, 106e, and 106f. Distal support 106a, proximate support 106b, and lateral supports 106c, 106d, 106e, and 106f are sometimes collectively referred to herein as support system 106.

In one embodiment, distal support 106a could be a horizontal support used to mount a first one of troughs 104 such as, for example, trough 104a. In one embodiment, trough 104b could be mounted directly to trough 104a (as generally shown in FIG. 4), trough 104c could be mounted directly to trough 104b, and trough 104d could be mounted directly to trough 104c. In another embodiment, troughs 104b, 104c, and 104d could each be mounted on lateral supports 106d, 106e, and 106f, rather than on another respective one of troughs 104 or on distal support 106a.

Lateral supports 106c, 106d, 106e, and 106f could be disposed generally perpendicular to distal support 106a and proximate support 106b as shown in FIG. 1. Each of lateral supports 106c, 106d, 106e, and 106f could be disposed spaced apart from one another as also shown in FIG. 1. It should, however, be understood that any suitable number, size, shape, overall look, appearance, configuration, or utility for distal support 106a, proximate support 106b, and lateral supports 106c, 106d, 106e, and 106f could be used in accordance with the present disclosure.

Mounting brackets 108 generally include any suitable structure disposed on troughs 104 to aid in mounting or otherwise retaining troughs 104 to support systems 106. Mounting brackets 108 could be a generally concave structure as shown in FIGS. 1-3. Although FIGS. 1-3 generally illustrate three mounting brackets 108 for each of troughs 104, it should be understood that any suitable number of mounting brackets 108 could be used in accordance with the present disclosure.

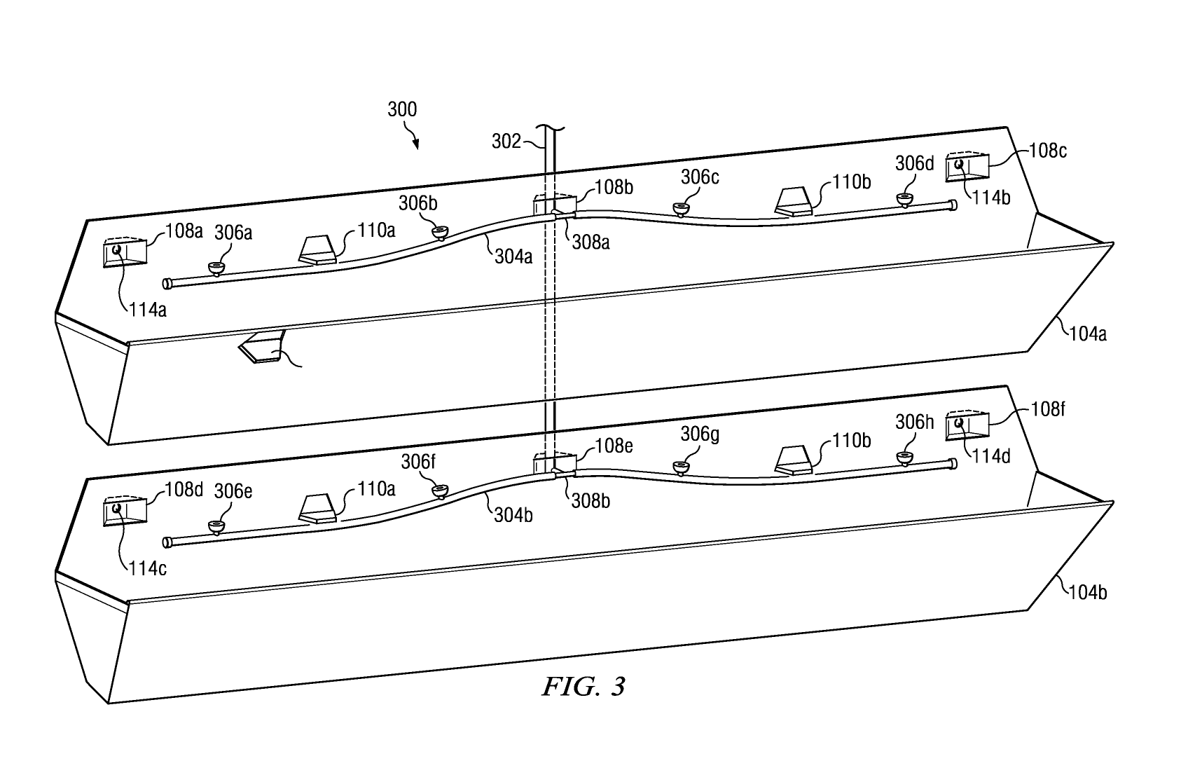

In one embodiment, mounting brackets 108 could be an appendage of or part of troughs 104. In other embodiments, mounting brackets 108 could be a separate piece disposed on troughs 104. Mounting brackets 108 could be made of the same materials as troughs 104 or be made of any other suitable material. In one embodiment, mounting brackets 108 could include an aperture (apertures 114a, 114b, 114c, and 114d are generally shown in FIG. 3 and are collectively referred to herein as apertures 114).

Apertures 114 could be configured to accept a screw, wood screw, metal screw, masonry screw, mounting screw, anchor, masonry anchor, expansion anchor, threaded anchor, bolt, nail, bit, bore, other mounting device, or any combination thereof (see mounting anchors 402a and 402b in FIG. 4). In one embodiment, apertures 114 could retain mounting bracket 108 and thus troughs 104 to support systems 106, as generally illustrated in, for example, FIGS. 1 and 3.

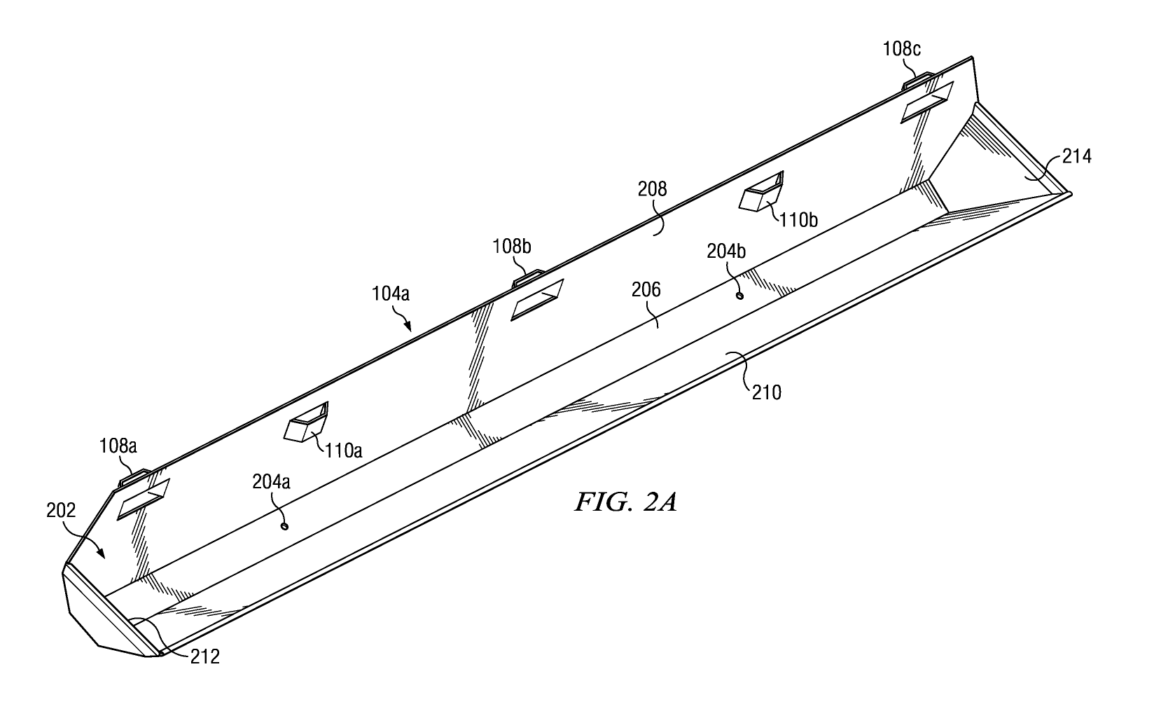

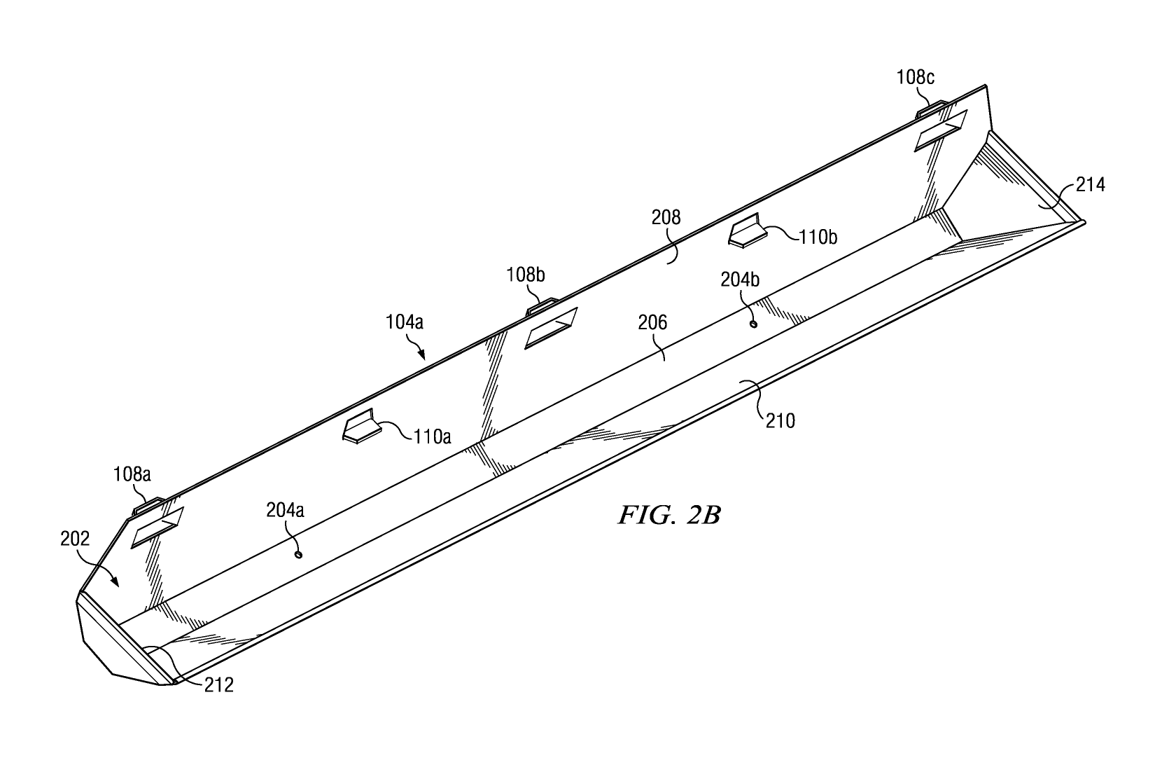

Guides 110 are generally disposed on troughs 104 to aid in leveling or positioning troughs 104 relative to another one of troughs 104, support systems 106, and the ground. In one embodiment, guides 110 could include any suitable size, shape, or configuration. For example, in one embodiment, guides 110 could be a generally convex structure as shown in FIG. 2A, or a relatively flat tab-like structure as shown in FIG. 2B.

In one embodiment, guides 110 could be an appendage of or part of troughs 104. In other embodiments, guides 110 could be a separate piece disposed on troughs 104. Guides 110 could be made of the same materials as troughs 104 or be made of any other suitable material. Although FIGS. 1-3 generally illustrate two guides 110 for each of troughs 104, it should be understood that any suitable number of guides 110 could be used in accordance with the present disclosure.

Plants 112 shown in FIG. 1 could include any suitable plants, miniature trees, shrubs, flowers, herbs, horticulture, soils, dirt, hydroponic materials, fertilizers, stones, shells, decorative items, novelty items, other suitable materials, or any combination thereof arranged in any suitable manner in troughs 104.

FIGS. 2A and 2B are exemplary perspective views into compartment 202 of trough 104a shown in FIG. 1. It should be understood that inner compartments 202 shown in FIGS. 2A and 2B are for illustrative purposes only and that any other suitable system or subsystem could be used in conjunction with or in lieu of inner compartment 202 according to one embodiment of the present disclosure. In addition, although the description below describes trough 104a, it should be understood any one of troughs 104 could be configured as described below.

Compartment 202 could generally be configured as an interior or interior portion of trough 104a (or any other one of troughs 104). In one embodiment, compartment 202 could include apertures or drainage holes 204a and 204b (collectively referred to herein as drainage holes 204), bottom surface 206, back surface 208, front surface 210, proximate side surface 212, and distal side surface 214.

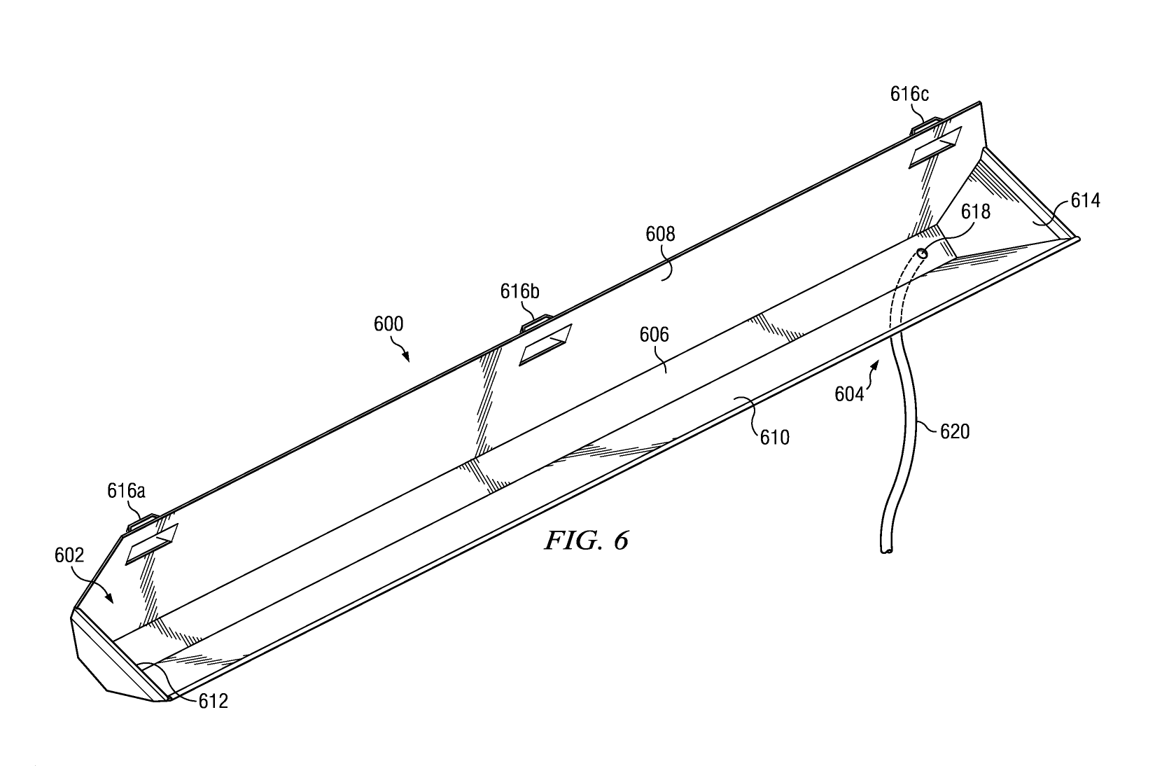

Each of drainage holes 204 could form separate channels from compartment 202 to an outer surface of trough 104a and thus to the area below trough 104a. Although compartment 202 is illustrated with five generally circular shaped drainage holes 204 disposed on bottom surface 206 in FIGS. 2A and 2B, it should be understood that any suitable number (or none at all), location, size, shape, or configuration of drainage holes 204 could be used in accordance with the present disclosure including for example, slits or grill-like drainage systems disposed on one or more locations on trough 104a. In some embodiments, any drainage from trough 104a could flow to trough 104b shown in FIG. 1 while, in other embodiments, any drainage from trough 104a could flow to end trough 600 shown in FIG. 6.

In one embodiment, bottom surface 206, back surface 208, front surface 210, proximate side surface 212, and distal side surface 214 could be disposed in an angled manner relative to another one of those surfaces. For example, as shown in FIGS. 2A, 2B, and 4, front surface 210 could be disposed in an angled manner relative to bottom surface 206 rather than disposed in a relatively perpendicular manner to ease drainage in trough 104a. It should be understood that compartment 202 could include any other suitable draining system or combination of system in accordance with the present disclosure.

FIG. 3 is an illustration of an exemplary irrigation system 300 for use in conjunction with a modular wall planter system such as, for example, system 100 shown in FIG. 1 according to one embodiment of the present disclosure. It should be understood that irrigation system 300 shown in FIG. 3 is for illustrative purposes only and that any other suitable system or subsystem could be used in conjunction with or in lieu of irrigation system 300 according to one embodiment of the present disclosure. Also illustrated in FIG. 3 are mounting brackets 108d, 108e, and 108f and guides 110c and 110d associated with exemplary trough 104b.

In FIG. 3, irrigation system 300 is shown in conjunction with troughs 104a and 104b. It should be understood, however, that irrigation system 300 could be used in conjunction with any suitable number of or configurations of troughs 104. Irrigation system 300 could include main line 302, secondary lines 304a and 304b (collectively referred to herein as secondary lines 304), outputs 306a, 306b, 306c, 306d, 306e, 306f, 306g, and 306h (collectively referred to herein as outputs 306), and connectors 308a and 308b (collectively referred to herein as connectors 308).

In one embodiment, main line 302 and secondary lines 304 could be made of any suitable material having a flexible or rigid quality and could further be used as a conduit for fluids including, for example, rubber, plastic, thermoplastic, piping material, silicon, garden hose material, other materials suitable for use as a conduit, or any combination thereof.

Main line 302 and secondary lines 304 could be used to direct any desired fluid to troughs 104 according to one embodiment of the present disclosure. Main line 302 and secondary lines 304 could be used to direct water, enhanced water mixtures, fertilizer, plant food, minerals, phosphates, amino acids, hydroponic materials, other suitable materials, or any combination thereof to troughs 104. In one embodiment, main line 302 could, for example, be connected to a water source and other sources of such materials and, ultimately, act as a conduit of those materials to all or selective number of troughs 104. In one embodiment, one or both of main line 302 and secondary lines 304 could include openings or piercings to supply any desired fluid to troughs 104. Although the water source and other sources of materials are not shown in FIGS. 1-9, it should be understood that the water source and other sources could be any suitable source fluidly connected and configurable to main line 302.

Secondary lines 304 could be fluidly connected and configurable to main line 302 through the use of connectors 308. For example, as shown in FIG. 3, main line 302 is fluidly connected to secondary line 304a via connector 308a, while main line 302 is fluidly connected to secondary line 304b via connector 308b. In one embodiment, connectors 308 could be made of any suitable materials including, for example, rubber, plastic, thermoplastic, piping material, silicon, garden hose material, other materials suitable for use as a connector, or any combination thereof. In one embodiment, connectors 308 could include screw holes similar to apertures 114 (not shown in FIG. 3). Although two generally horizontally disposed secondary lines 304 are shown in FIG. 3, it should be understood that suitable number (or none at all), location, size, shape, or configuration of secondary lines 304 could be used in accordance with the present disclosure.

Outlets 306 could be fluidly connected and configurable to secondary lines 304. In one embodiment, Outlets 306 could include any spout, spray apparatus, sprinkler head, mister, aperture, conduit, other suitable apparatus to distribute fluids from secondary lines 304, or any combination thereof. Outlets 306 could be directed to distribute fluids in a particular direction, intensity, amount, pattern, other suitable characteristic, or any combination thereof. In one embodiment, outlets 306 could include a filtering system to filter fluids from secondary lines 304. Although four generally horizontally circular outlets 306 are shown in FIG. 3, it should be understood that suitable number (or none at all), location, size, shape, or configuration of outlets 306 could be used in accordance with the present disclosure.

FIG. 4 is a perspective view of a portion of system 100 shown in FIG. 1 without surface 102. It should be understood that system 100 shown in FIG. 4 is for illustrative purposes only and that any other suitable system or subsystem could be used in conjunction with or in lieu of system 100 according to one embodiment of the present disclosure. In one embodiment, the portion of system 100 shown in FIG. 4 could include troughs 104a and 104b, mounting brackets 108a and 108d, guides 110a and 110c, main line 302, and mounting anchors 402a and 402b.

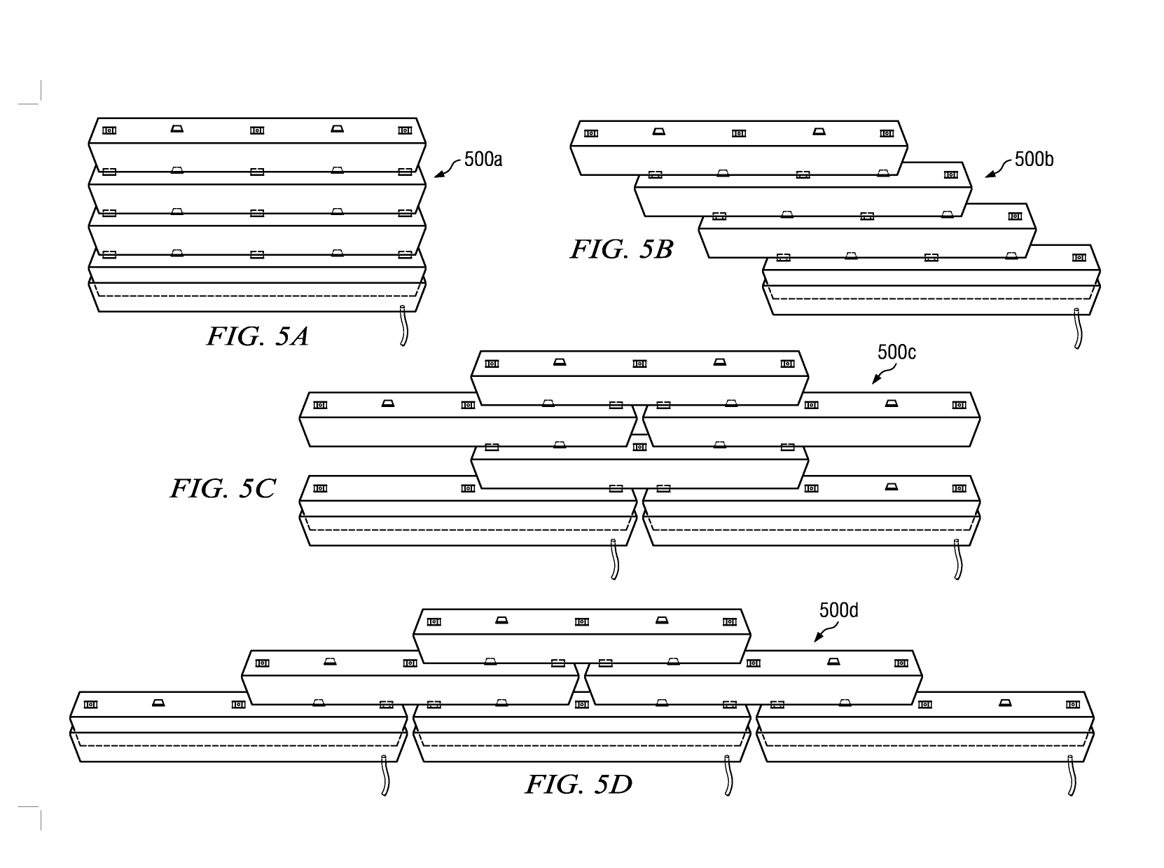

FIGS. 5A, 5B, 5C, and 5D are exemplary configurations 500a, 500b, 500c, and 500d for troughs 104 for use in a modular planter system such as, for example, system 100 according to one embodiment of the present disclosure. Configurations 500a, 500b, 500c, and 500d are collectively referred to herein as configurations 500. It should be understood that configurations 500 shown in FIGS. 5a, 5b, 5c, and 5d are for illustrative purposes only and that any other suitable system or subsystem could be used in conjunction with or in lieu of configurations 500 according to one embodiment of the present disclosure.

Configuration 500a could include troughs 104 in a generally uniform vertically stacked styled modular planter system, while configuration 500b could include a graduated or one-off vertically stacked styled modular planter system. Configurations 500c and configurations 500d could include troughs 104 in a generally vertically stacked and patterned styled modular planter system. It should be understood that troughs 104 could be placed in any suitable configuration or pattern according to one embodiment of the present disclosure.

FIG. 6 is an exemplary perspective view of a drainage recapture trough or end trough 600 according to one embodiment of the present disclosure. It should be understood that end trough 600 shown in FIG. 6 is for illustrative purposes only and that any other suitable system or subsystem could be used in conjunction with or in lieu of end trough 600 according to one embodiment of the present disclosure.

End trough 600 could be configured similarly to troughs 104 described above and with or without, for example, drainage holes 204 and guides 110. In one embodiment shown in FIG. 6, compartment 602 could include drainage return 604, bottom surface 606, back surface 608, front surface 610, proximate side surface 612, and distal side surface 614. End trough 600 could also include mounting brackets 616a, 616b, and 616c (collectively referred to herein as mounting brackets 616). In addition, drainage return 604 could include drainage release hole 618 and drainage release hose 620.

Drainage release hole 618 shown in FIG. 6 could generally be disposed on bottom surface 606 and fluidly connected and configured to drainage release hose 620. Drainage release hole 618 and drainage release hose 620 could generally direct any overflow or drainage of fluid from compartment 602 to an end location such as, for example, a closed container, open container, ambient environment, storage device, recycling device, any other suitable location or purpose, or any combination thereof to receive such overflow or drainage.

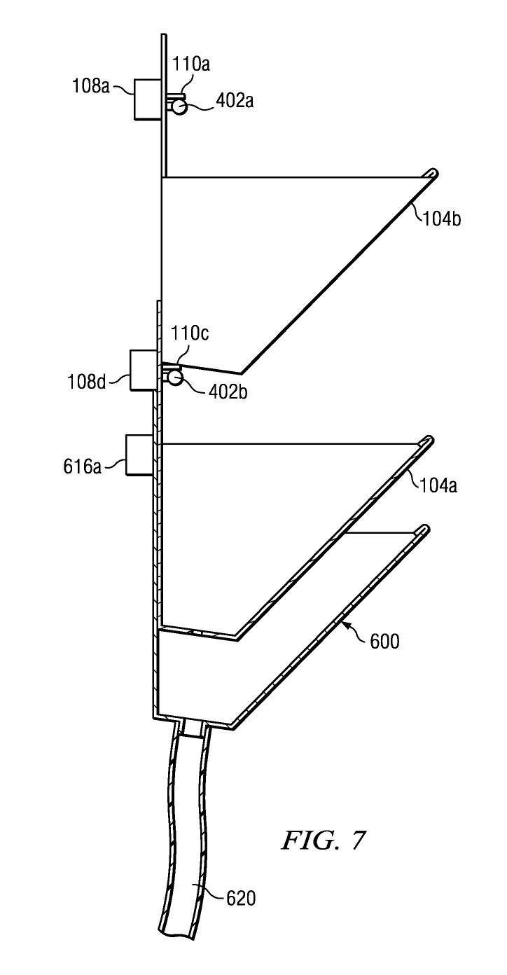

FIG. 7 is an exemplary modular planter and drainage recovery system 700 (similar to system 100) that could incorporate the use of end trough 600 shown in FIG. 6 according to one embodiment of the present disclosure. It should be understood that system 700 shown in FIG. 7 is for illustrative purposes only and that any other suitable system or subsystem could be used in conjunction with or in lieu of system 700 according to one embodiment of the present disclosure.

System 700 could include troughs 104a and 104b, mounting brackets 108a and 108d, guides 110a and 110c, main line 302, mounting anchors 402a and 402b, end trough 600, drainage release hole 618, and drainage release hose 620 as described in the description accompanying FIGS. 1, 3, 4, and 6 above. In one embodiment, drainage release hole 618 and drainage release hose 620 could generally direct any overflow or drainage of fluid from compartment 602 to an end location such as, for example, a closed container, open container, ambient environment, storage device, recycling device, any other suitable location or purpose, or any combination thereof to receive such overflow or drainage.

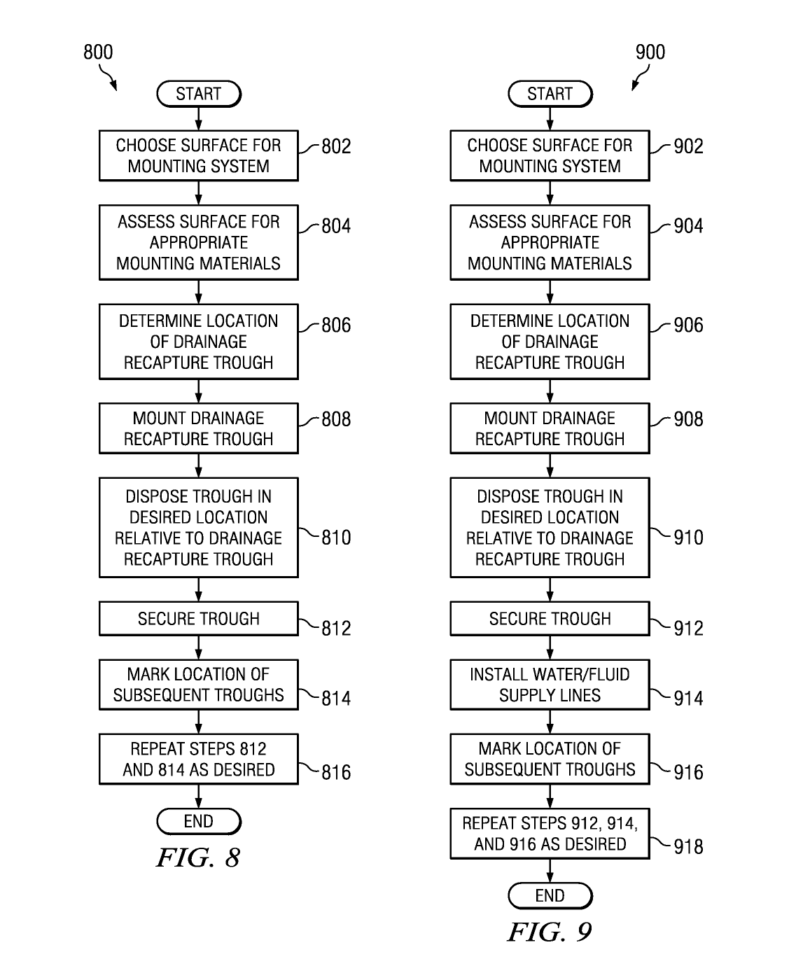

FIG. 8 is an exemplary method 800 of providing a modular planter system or display such as, for example, system 100 according to one embodiment of the present disclosure. It should be understood that method 800 shown in FIG. 8 is for illustrative purposes only and that any other suitable method or sub-method could be used in conjunction with or in lieu of method 800 according to one embodiment of the present disclosure. It should also be understood that the steps of method 800 could be performed in any suitable order or manner in accordance with the present disclosure.

In step 802, a location could be chosen on a wall or relative to a surface such as, for example, surface 102. In one embodiment, the location could be generally perpendicular to the horizontal plane force of gravity and in accordance with the weight requirements of the particular application. For example, trough 104a with the proper amount of potting soil could weigh an average of about 18 pounds per square foot of surface. The choice of a structurally support system 106 could thus be limited to those surfaces or wall that could support and manage such weight.

In step 804, method 800 could continue with preparing support systems 106 and determining the material of support systems 106 and accordingly choosing the appropriate anchoring systems such as, for example, mounting anchors 402. For example, depending on surface 102, support systems 106, mounting anchors 402 could be a screw, wood screw, metal screw, masonry screw, or mounting screw.

If applicable, in step 806, method 800 could continue with determining a desirable location for the drainage recapture trough such as, for example, end trough 600 and placing end trough 600 against the wall and positioned generally level on a horizontal plane.

In step 808, method 800 could continue with mounting end trough 600 with an appropriate anchoring system such as, for example, mounting anchor 402 using a mounting bracket on trough 600 such as, for example, mounting brackets 616. In one embodiment, appropriate mounting anchor 402 should have a head large enough to secure mounting bracket 616. Accordingly, end trough 600 could be secured to the wall without slipping through a mounting hole associated with mounting bracket 616.

In step 810, method 800 could continue with placing a first modular planter such as, for example, one of troughs 104 vertically above end trough 600 such that mounting brackets 106a, 106b, and 106c of trough 104a are disposed against the top of end trough 106. In one embodiment, trough 104a is generally disposed level on a horizontal line equal to end trough 600. Accordingly, in one particular embodiment, when properly placed, apertures 114 associated with mounting brackets 106 could approximately be 2⅛″ above the screw holes of end trough 600.

In step 812, once step 810 is complete, method 800 could continue with securing mounting anchor 402 through apertures 114 of mounting brackets 106 to secure trough 104a to support systems 106. Accordingly, when the installation of end trough 600 and trough 104a is complete, the respective apertures 114 and mounting holes associated with end trough 600 could be approximately 5¾″ apart on a vertical line.

In step 814, method 800 could continue to determine a suitable number of additional troughs 104 used on support systems 106. In one embodiment, this determination could be made by marking off prospective anchor holes for each additional troughs 104 every 5¾″ (or other appropriate measurement). Method 800 could thereby determine the number of troughs that could be stacked in a particular area of support systems 106.

Step 814 could also include determining the type of design for system 100 and thereby moving consecutive troughs to the left or right as far as preferred taking care that drain holes 204 of troughs 104 will flow into a respective one of troughs 104 below it and also taking care that subsequent planters are leveled correctly using guides 110 as described above.

In step 816, method 800 could continue with steps 812 and 814 (or any other suitable steps or sub-steps) until the desired design for system 100 is achieved.

FIG. 9 is an exemplary method of providing a modular planter system having an irrigation system such as, for example, the irrigation system shown in FIG. 3. It should be understood that method 900 shown in FIG. 9 is for illustrative purposes only and that any other suitable method or sub-method could be used in conjunction with or in lieu of method 900 according to one embodiment of the present disclosure. It should also be understood that the steps of method 900 could be performed in any suitable order or manner in accordance with the present disclosure.

In step 902, a location could be chosen on a wall or surface such as, for example, surface 102 and/or support systems 106. In one embodiment, the location could be generally perpendicular to the horizontal plane force of gravity and in accordance with the weight requirements of the particular application. For example, trough 104a with the proper amount of potting soil could weigh an average of about 18 pounds per square foot of surface. The choice of a structurally sound support system 106 could thus be limited to those surfaces or wall that could support and manage such weight.

In step 904, method 900 could continue with preparing support systems 106 and determining the material of support systems 106 and accordingly choosing the appropriate anchoring systems such as, for example, mounting anchors 402. For example, depending on support systems 106, mounting anchors 402 could be a screw, wood screw, metal screw, masonry screw, or mounting screw.

If applicable, in step 906, method 900 could continue with determining a desirable location for the drainage recapture trough such as, for example, end trough 600 and placing end trough 600 against the wall and positioned generally level on a horizontal plane.

In step 908, method 900 could continue with mounting end trough 600 with an appropriate anchoring system such as, for example, mounting anchor 402 using a mounting bracket on trough 600 such as, for example, mounting brackets 616. In one embodiment, appropriate mounting anchor 402 should have a head large enough to secure mounting bracket 616. Accordingly, end trough 600 could be secured to the wall without slipping through a mounting hole associated with mounting bracket 616.

In step 910, method 900 could continue with placing a first modular planter such as, for example, one of troughs 104 vertically above end trough 600 such that mounting brackets 106a, 106b, and 106c of trough 104a are disposed against the top of end trough 106. In one embodiment, trough 104a is generally disposed level on a horizontal line equal to end trough 600. Accordingly, in one particular embodiment, when properly placed, apertures 114 associated with mounting brackets 106 could approximately be 2⅛″ above the screw holes of end trough 600.

In step 912, method 900 could continue with securing mounting anchor 402 through apertures 114 of mounting brackets 106 to secure trough 104a to support systems 106. Accordingly, when the installation of end trough 600 and trough 104a is complete, the respective apertures 114 and mounting holes associated with end trough 600 could be approximately 5¾″ apart on a vertical line.

In step 914, the main water/fluid supply line such as, for example, main line 302 could be installed on trough 104a. Secondary supply lines such as, for example, secondary lines 304 could be fluidly connected and configured to main line 302 through the use of connectors such as, for example, 308.

In step 916, method 900 could continue to determine a suitable number of additional troughs 104 used on support systems 106. In one embodiment, this determination could be made by marking off prospective anchor holes for each additional troughs 104 every 5¾″ (or other appropriate measurement). Method 900 could thereby determine the number of troughs that could be stacked in a particular area of support systems 106.

Step 916 could also include determining the type of design for system 100 and thereby moving consecutive troughs to the left or right as far as preferred taking care that drain holes 204 of troughs 104 will flow into a respective one of troughs 104 below it and also taking care that subsequent planters are leveled correctly using guides 110 as described above.

In step 918, method 900 could continue with steps 912, 914, and 916 (or any other suitable steps or sub-steps) until the desired design for system 100 is achieved.

It may be advantageous to set forth definitions of certain words and phrases used in this patent document. The term “couple” and its derivatives could refer to any direct or indirect communication between two or more elements, whether or not those elements are in physical contact with one another. The terms “include” and “comprise,” as well as derivatives thereof, could mean inclusion without limitation. The term “or” could be inclusive, meaning and/or. The phrases “associated with” and “associated therewith,” as well as derivatives thereof, could mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A modular planting system comprising:
a vertically disposed frame;
a removable trough having a retaining structure to position the trough relative to the frame; and
an irrigation system having an outlet disposed above the trough.

2. The system of claim 1, wherein the trough comprises an elongated body having a bottom surface, a back surface, and a front surface.

3. The system of claim 2, wherein the front surface comprises an angled surface.

4. The system of claim 2, wherein the back surface comprises a mounting bracket.

5. The system of claim 2, wherein the back surface comprises a positioning guide structure.

6. The system of claim 1 further comprising:
a drainage hole disposed on a bottom surface of the trough.

7. The system of claim 1 further comprising:
an end trough to capture water drainage from the trough.

8. The system of claim 1, wherein the irrigation system is configured to supply fertilizer to the water delivered to the trough.

9. The system of claim 1 further comprising:
a second trough having a mounting bracket to retain the second trough to the trough.

10. A modular planting system comprising:
a vertically disposed frame;
a first trough having a first support to selectively position the first trough relative to the frame;
a second trough having a second support to retain the second trough to the first trough; and
an irrigation system having an outlet disposed above the first trough and the second trough.

11. The system of claim 10, wherein the first trough and the second trough comprise a generally tapered body.

12. The system of claim 10, wherein the first trough comprises a mounting bracket on a back surface of the first trough.

13. The system of claim 10, wherein the first trough comprises a guide structure to aid in disposing the second trough in a desired position relative to the first trough.

14. The system of claim 10 further comprising:
a drainage hole disposed on a bottom surface of the first trough and the second trough.

15. The system of claim 10 further comprising:
an end trough to capture water drainage from at least one of: the first trough and the second trough.

16. The system of claim 10, wherein the irrigation system is configured to supply fertilizer to the water delivered to the first trough and the second trough.

17. A modular planting system comprising:
a vertically disposed frame;
a first removable trough having a first support to position the first trough relative to the frame;
a second removable trough having a second support to position the second trough relative to the frame;
an irrigation system to supply water to the first and second troughs; and
and end trough to capture any water drainage from the second trough.

18. The system of claim 17, wherein the first trough and the second trough comprise a generally tapered body.

19. The system of claim 17, wherein the first trough comprises a guide structure to aid in disposing the second trough in a desired position relative to the first trough.

20. The system of claim 17, wherein the irrigation system supplies fertilizer to the water delivered to the first trough and the second trough.
